(19) United States
(12) Patent Application Publication
(10) Pub. No.: US 2018/0326499 A1
(43) Pub. Date: Nov. 15, 2018

(54) WHEEL RECUTTING

(71) Applicant: Paul MCBRIDE, Fareham, Hampshire (GB)

(72) Inventor: Paul MCBRIDE, Fareham, Hampshire (GB)

(21) Appl. No.: 15/776,631

(22) PCT Filed: Nov. 17, 2016
(86) PCT No.: PCT/GB2016/053589

§ 371 Date: May 16, 2018

(30) Foreign Application Priority Data
Nov. 17, 2015 (GB) 1520279.9

(51) Int. Cl. B23B 5/28; B23P 6/00; B23Q 15/24; B23Q 17/20; B23Q 17/22; G01N 27/90

(52) U.S. Cl. CPC B23B 5/28; B23P 6/00; B23Q 15/24; B23Q 17/20; B23B 2270/36; G01N 27/90; B23B 2215/08; B23B 2260/128; B23Q 17/2233

(57) ABSTRACT

A method of recutting the surface of a wheel includes mounting the wheel on a rotatable mount, moving a probe across the surface of the wheel between an outer radial position and an inner radial position to obtain a radial surface profile and rotating the wheel about its axis on the rotatable mount. During rotation of the wheel, the position of a cutting tool with respect to the surface of the wheel is controlled to recut the surface of the wheel in accordance with the cutting profile. The wheel is tagged with a unique wheel identifier, and the unique wheel identifier is recorded into a database in association with an indication of an amount of material which has been removed from the surface of the wheel.

### BACKGROUND OF THE INVENTION

### Field of the Invention

The present invention relates to a method and apparatus for recutting wheels.

### Brief Description of the Related Art

Alloy vehicle wheels may be provided with a “diamond turned” finish by mounting the wheel onto a lathe and turning the front face of the wheel to leave a mirror like finish. This finish is then preserved by applying a transparent lacquer coating to the lathe-turned face. However, the lacquer may become damaged during normal use of the wheel by for example ultra violet sunlight or mechanical impacts. This damage may allow water and air to come into contact with the machined aluminium face, which in turn oxidizes (corrodes) and ruins the aesthetic appearance of the wheel.

This damage can be repaired using a lathe and cutting tool to follow the radial profile of the wheel to remove the lacquer and top layer of oxidized alloy. This repair process may be conducted either by way of a semi-automated method using a touch (contact) probe to “map” a user selected radial profile and then automatically following the mapped profile with a cutting tool, or alternatively by using a manual lathe—with an operator guiding the cutting tool across the radial profile of the wheel using their best judgement.

There are a number of problems associated with current techniques, including the fact that repeatedly removing material from the front face of the wheel may eventually mechanically weaken the wheel, the fact that removing the tyre from the wheel prior to the profile mapping and cutting leads to an increase in the time required for the process, the fact that some damage to the wheel may be structural rather than aesthetic, and the fact that lateral deflection of a touch probe may lead to erroneous results. Embodiments of the present invention seek to alleviate some of these problems.

### SUMMARY OF THE INVENTION

According to an aspect of the invention there is provided a method of recutting the surface of a wheel, the method comprising the steps of:

mounting the wheel on a rotatable mount;

moving a probe across the surface of the wheel between an outer radial position and an inner radial position to obtain a radial surface profile;

rotating the wheel about its axis on the rotatable mount;

during rotation of the wheel, controlling the position of a cutting tool with respect to the surface of the wheel to recut the surface of the wheel in accordance with the cutting profile;

tagging the wheel with a unique wheel identifier; and

recording the unique wheel identifier into a database in association with an indication of an amount of material which has been removed from the surface of the wheel.

The method may further comprise storing a vehicle identification code into the database in association with the unique wheel identifier, the vehicle identification code uniquely identifying the vehicle associated with the wheel. The vehicle identification code may for example be a chassis number.

The method may further comprise reading the unique wheel identifier prior to recutting the surface of the wheel and using the unique wheel identifier to obtain from the database an indication of the amount of material which has been previously removed from the surface of the wheel. The method may then comprise updating in the database the indication of the amount of material removed from the surface of the wheel to include the amount of material newly removed by the recutting process. The amount of material indicated as being removed may be the depth of the cut made in the recutting process.

According to another aspect of the invention, there is provided an apparatus for recutting the surface of a wheel, comprising:

a rotatable mount for receiving the wheel, and for permitting rotation of the wheel;

a probe, mounted to be movable across the surface of the wheel between an outer radial position and an inner radial position to obtain a radial surface profile;

a controller, operable during rotation of the wheel to control the position of a cutting tool with respect to the surface of the wheel to recut the surface of the wheel in accordance with the cutting profile;

a tag bearing a unique wheel identifier; and

a data connection, for recording the unique wheel identifier into a database in association with an indication of an amount of material which has been removed from the surface of the wheel.

According to another aspect of the invention, there is provided an apparatus for recutting the surface of a wheel, comprising:

a rotatable mount for receiving the wheel, and for permitting rotation of the wheel;

a probe, mounted to be movable across the surface of the wheel between an outer radial position and an inner radial position to obtain a radial surface profile;

a controller, operable during rotation of the wheel to control the position of a cutting tool with respect to the surface of the wheel to recut the surface of the wheel in accordance with the cutting profile;

wherein the probe comprises an extendable probe arm and a support arm, the support arm comprising a shaft mounted within a sleeve, the probe arm comprising a shaft mounted within a sleeve, and a sensor for detecting the position of the shaft within the sleeve, wherein the sleeve of the support arm and the sleeve of the probe arm are rigidly fixed together and the shaft of the support arm and the shaft of the probe arm are rigidly fixed together.

The apparatus may comprise an arm mount bearing the cutting tool. The probe may be removably mountable to the arm mount.

The shaft of the probe arm and the shaft of the support arm may be fixed together via a contact block carrying a contact point for contacting the surface of the wheel.

According to another aspect of the present invention, there is provided a method of detecting structural damage to a wheel, comprising:

generating an electric field proximate the surface of the wheel to induce an eddy current;

detecting a disturbance in the eddy current circulation caused by a crack; and

generating an indication that a crack has been detected.

According to another aspect of the present invention, there is provided an apparatus for recutting the surface of a wheel, comprising:

a rotatable mount for receiving the wheel, and for permitting rotation of the wheel;

a probe, mounted to be movable across the surface of the wheel between an outer radial position and an inner radial position to obtain a radial surface profile;

a controller, operable during rotation of the wheel to control the position of a cutting tool with respect to the surface of the wheel to recut the surface of the wheel in accordance with the cutting profile; and

a fault detector for generating an electric field proximate the surface of the wheel to induce an eddy current, detecting a disturbance in the eddy current circulation caused by a crack, and generating an indication that a crack has been detected.

According to another aspect of the present invention, there is provided a method of recutting the front face surface of a wheel, the method comprising the steps of:

mounting the wheel on a rotatable mount;

urging the tyre away from the front face of the wheel to expose a circumferential portion of the wheel;

fitting a clamp around the exposed portion of the wheel to inhibit the tyre from returning to its original position near the front face of the wheel;

moving a probe across the surface of the wheel between an outer radial position and an inner radial position to obtain a radial surface profile;

rotating the wheel about its axis on the rotatable mount; and

during rotation of the wheel, controlling the position of a cutting tool with respect to the surface of the wheel to recut the surface of the wheel in accordance with the cutting profile.

According to another aspect of the present invention, there is provided an apparatus for recutting the front face surface of a wheel, the apparatus comprising:

a rotatable mount for receiving the wheel;

a clamp, for fitting around an exposed portion of the wheel when the tyre has been urged away from the front face of the wheel, to inhibit the tyre from returning to its original position near the front face of the wheel;

a probe, mounted to be movable across the surface of the wheel between an outer radial position and an inner radial position to obtain a radial surface profile; and

a controller, operable during rotation of the wheel to control the position of a cutting tool with respect to the surface of the wheel to recut the surface of the wheel in accordance with the cutting profile.

The clamp may comprise a first arcuate strip and a second arcuate strip which can be bolted together about the circumference of the wheel.

### BRIEF DESCRIPTION OF THE DRAWINGS

To help understanding of the invention, a specific embodiment thereof will now be described by way of example and with reference to the accompanying drawings, in which:

FIG. 1 schematically illustrates a recutting apparatus;

FIG. 2 is a schematic flow diagram of a recutting method;

FIG. 3 schematically illustrates the use of a clamp to retain a tyre away from a wheel surface to be recut; and

FIG. 4 schematically illustrates a probe in both retracted and extended positions.

### DETAILED DESCRIPTION OF THE PREFERRED EMBODIMENTS

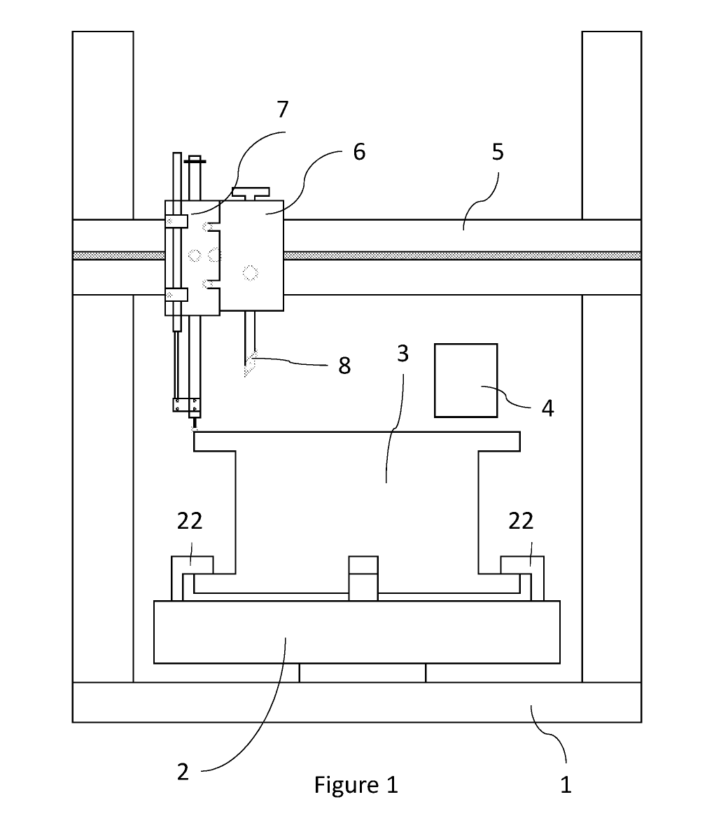

Referring to FIG. 1, a recutting apparatus is shown, which comprises a housing and frame 1, a rotatable mount 2, a wheel 3 (without a tyre) mounted onto the rotatable mount 2 using retainers 22 which grip a rim of the wheel 3 distal from the front face of the wheel 3, a fault detector 4 positioned just above the surface of the wheel and a positioner 5 which provides for horizontal (radial) and vertical positioning of a mounting block 6 with respect to the wheel 3. The mounting block 6 carries a probe 7 and a cutting tool 8. The cutting tool 8 is permanently fixed to the mounting block 6. The probe 7 is removably attachable to the mounting block 6, and in particularly is mounted in place in order to determine a cutting profile by tracking over the surface of the wheel, but is removed once this has been determined in order that the cutting tool 8 is able to approach and engage with the surface of the wheel 3 to conduct a cutting operation. The fault detector 4 is an eddy current probe which contains one or more coils which generate an oscillating magnetic field which interacts with the aluminium of the wheel 3 to induce eddy currents (circular flows of electrons) therein. The eddy current in turn generates its own magnetic field, which interacts with the coils in the probe by way of mutual inductance. Any cracks in the wheel 3 will disturb the eddy currents, causing an impedance change at the coil. This change can be registered as indicative of a fault (crack or other physical damage) in the wheel. The fault detector 4 can either be a separate device which is passed over the surface of the wheel manually by an operator to detect faults prior to undertaking a recutting operation (the wheel 3 can be slowly turned on the mount 2 to assist with this manual operation), or alternatively the fault detector 4 can be mounted to the positioner 5 (for example) and automatically passed over the surface of the wheel 3.

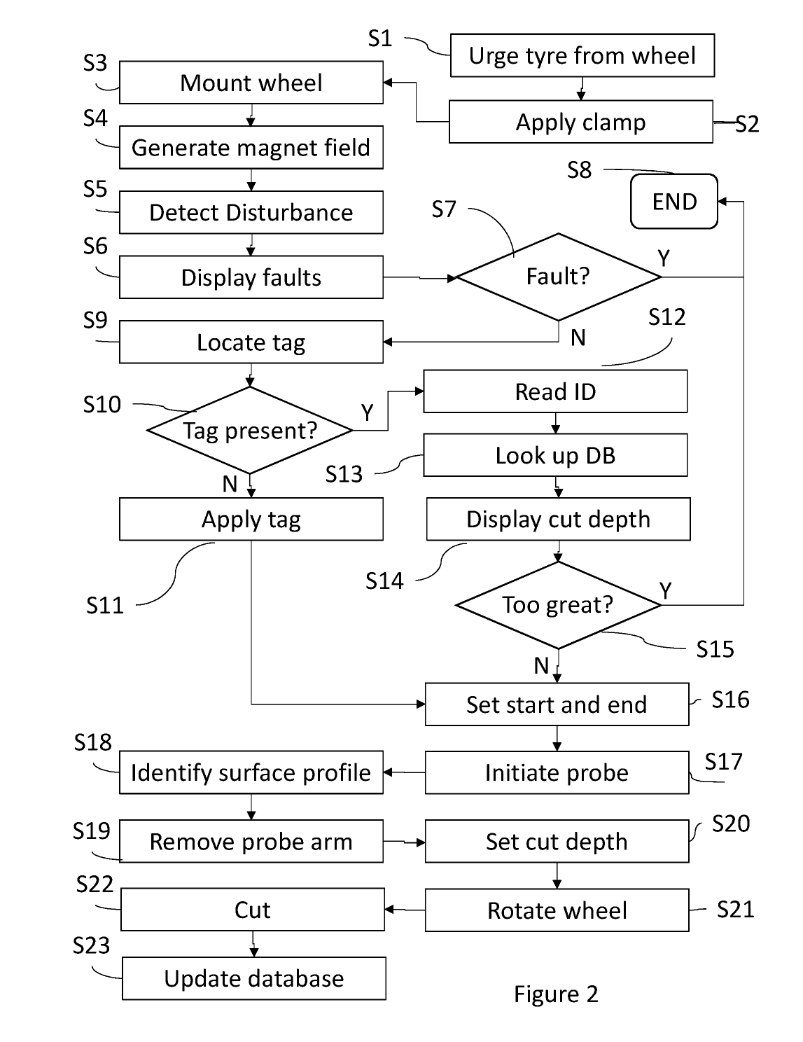

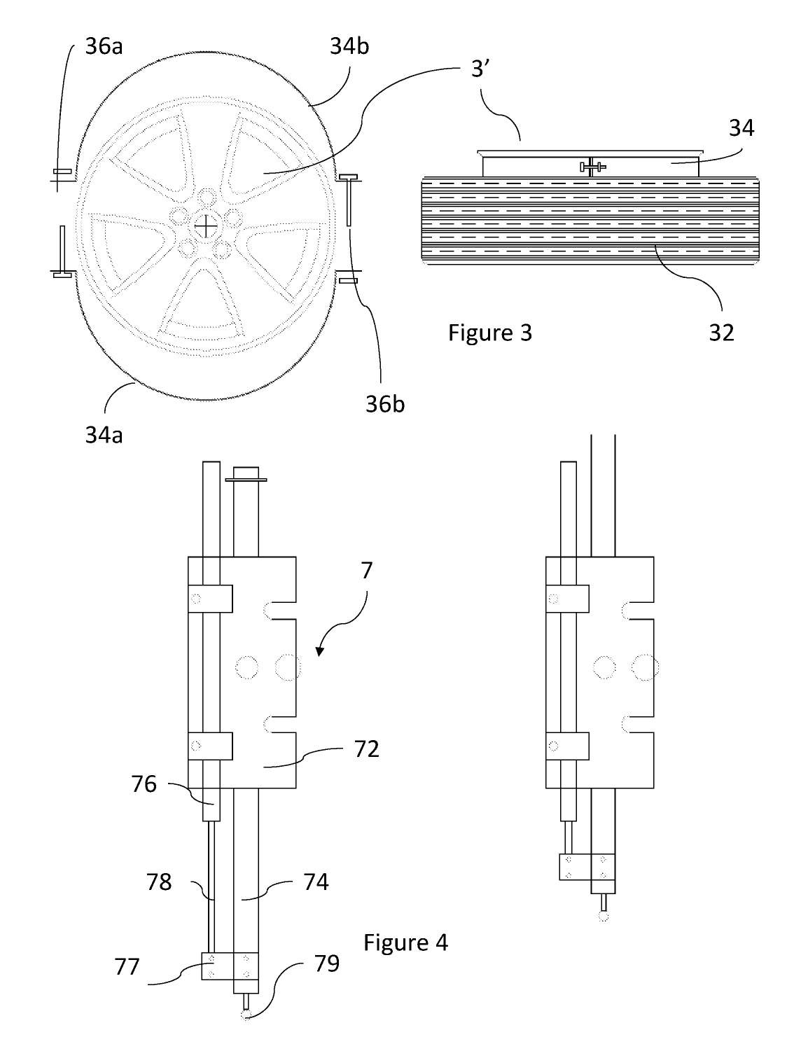

The operation of the apparatus of FIG. 1 will now be described with reference to the flow diagram of FIG. 2. Initially, a wheel to be recut can be expected to have a tyre on it. The tyre may obstruct the operation of the apparatus. Conventionally, this problem is addressed by removing the tyre from the wheel altogether before recutting, and this is the approach shown in FIG. 1 (the wheel 3 is shown without a tyre being present). However, it is possible to perform the recutting operation with the tyre still on the wheel. This requires two preliminary steps, S1 and S2. In particular, the step S1 requires the tyre to be urged away from the vicinity of the front face of the wheel, to expose a circumferential portion of the wheel (behind the rim). Then, at the step S2, a clamp is fitted around the exposed portion of the wheel adjacent the rim to inhibit the tyre from returning to its original position near the front face of the wheel. This keeps the tyre out of the way of the profiling and recutting operations, without needing to remove the tyre entirely. Once the wheel has been recut, the clamp can be removed and the tyre allowed to return to its normal position about the wheel. Referring briefly to FIG. 2, a wheel 3′ is shown to have a tyre 32 mounted thereon. A clamp 34 is fitted about the circumference of the wheel keeping the tyre 32 away from the front surface, permitting recutting to take place. The claim 34 is shown to include a first part 34a and a second part 34b. The two parts are coupled together about the wheel using bolts 36a, 36b, although it will be appreciated that one of these could be replaced with a hinge, or a single part clamp could be used instead. Returning briefly to FIG. 1, it will be appreciated that a modification to the retainers 22 will be required in order that the wheel 3′ can be secured to the rotatable mount (noting that the presence of the tyre prevents the use of the distal rim of the wheel from being used as a securement point). Alternatively, instead of using the retainers 22, the wheel may be secured to the rotatable mount by fixing to the holes (not shown) by which the wheel is usually attached to a vehicle.

At a step S3, the wheel 3 (or 3′) is secured to the rotatable mount 2. Then, the wheel is tested for faults (cracks or other physical damage) at steps S4, S5 and S6. It will be appreciated that the structural integrity of a wheel is important for safety reasons. Wheel recutting is a good opportunity to test this. However, some faults are not visible externally (or their severity is not apparent from surface inspection). The present technique uses an eddy current probe to test for internal cracks and other structural defects. At the step S4, the fault detector 4 generates a magnetic field in the proximity of the surface of the wheel by passing a current through a coil. This magnetic field penetrates the wheel and causes eddy currents as described above. At a step S5, disturbances in those eddy currents are detected in the coil of the fault detector 4. The faults are then displayed to an operator at a step S6. At the step S7, a decision is made as to whether to continue with the recutting operation or abandon it depending on whether a sufficiently serious fault has been found by the eddy current probe. In particular, if at the step S7 it is determined that the wheel 3, 3′ has a serious structural fault, then the recutting operation is abandoned at a step S8.

If on the other hand it is determined that the wheel 3, 3′ does not have a fault, or any faults are not serious, then the process continues on to a step S9, where a tag (if present) is located on the wheel. The tag may be at any convenient position, such as hidden by the tyre or on the reverse of the wheel. The tag may be a barcode or QR code, a magnetic strip, an RFID chip or any other tag which uniquely identifies the wheel. If it is found at a step S10 that no tag is present, then a tag is applied (for example adhered) at a step S11, and an entry is made in a tag database. The tag bears a unique identifier of the wheel (for example a unique alphanumeric code or bar code). The unique identifier is listed in the database, along with information regarding an amount (depth) of material which has been cut from the surface of the wheel, and optionally an identity of a vehicle which the wheel is associated with (for example a chassis number for the vehicle). Other information may optionally be stored, such as a wheel type, information on any detected faults (as found by the fault detector 4 for example), and a maximum permitted cut depth for the wheel type. The database may be made available to vehicle manufacturers so that they are aware of the state of wheels on their vehicles, or to owners or purchasers of vehicles who may have an interest in the repair state of the wheels. The unique identifier, and the vehicle identification may be manually entered into the database. If it is determined at the step S10 that a tag is already present, then the identifier for the tag is read at a step S12, and the entry for that wheel is obtained from the database at a step S13. The cut depth for the wheel is then displayed to the operator. In the case of the first recut, the cut depth would be zero, but as the wheel is repeatedly recut the cut depth listed in the database will increase. It will be appreciated that, for safety reasons, the surface of a wheel cannot be recut indefinitely. By recording cut depth in the database each time a cut is made, an operator of a recutting apparatus can make a judgement as to whether the wheel can be safely recut again. Optionally, a maximum safe cut depth for a wheel type may be stored in the database, and the actual cut depth can be compared against this (manually or automatically) to determine whether a further recut can safely be made. At a step S15, it is determined whether the amount of material previously cut from the surface of the wheel 3, 3′ is too great. If so, then the process ends at the step S8.

Otherwise, the process progresses to a step S16, where a start radial position and end radial position are set in preparation for a scanning operation. These positions may be set for example by manually manipulating the probe 7 into a desired position and selecting this (for example by pressing a button) as a start radial position, or an end radial position. The start radial position may be at or adjacent the rim of the wheel (the position of the probe in FIG. 1), while the end radial position may be towards the centre of the wheel (or vice versa). Optionally, the start and end radial positions may be pre-set parameters in the database, based on the wheel type, in which case no manual setting stage will be required. Once the start and end radial positions are set, then the probe scanning function is initiated at a step S17. In particular, the probe is moved automatically to the start radial position, and a contact point of the probe travels down to contact the surface of the wheel. It will be appreciated that the positioner 5 may be locked to a single vertical position for the duration of the surface profiling operation. The operator is able to freely rotate the wheel on its mount so that the contact point of the probe comes into contact with the most elevated part of the wheel at that radial position—for example on a spoke (rather than permitting the contact point and the probe to drop down between two spokes which would give an erroneous result). The vertical position of the contact point when it is in contact with the surface of the wheel is recorded, and the probe starts to move horizontally (radially) from the start radial position towards the end radial position. As the probe moves radially, the vertical position of its contact point will change to follow the surface topology of the wheel, and this vertical position as a function of radial position is recorded. The operator may rotate the wheel slowly as the probe moves radially, in order that the probe follows the most elevated part of the wheel at any radial position—for example by following the centre line of the spokes. This continues until the probe reaches the end radial position, at which point the contact point of the probe is lifted away from the surface of the wheel. The vertical position (surface elevation) recorded by the probe at different radial positions is used to generate a surface profile at a step S18 which effectively defines the most elevated point (circumferentially) at each radial position of the wheel.

At a step S19, the probe 7 is removed from the mounting block 6. This is because the probe 7 may interfere with the recutting operation. At a step S20, the cut depth (for example 1 mm) is set, which together with the surface profile enables a cutting profile to be determined. The cutting profile defines a vertical position which the cutting tool is moved to at each radial position of the wheel in order to give effect to a consistent cutting depth across the surface of the wheel (for example 1 mm). In other words, the cutting profile may effectively define a vertical position which is consistently 1 mm lower than the measured surface elevation of the wheel (surface profile). At a step S21, the wheel is rotatable by a motor (not shown) which drives the rotatable mount 2. At a step S22, the cutting tool is moved vertically down to engage with (and cut) the surface of the wheel, starting at the start radial position and then moving radially to the end radial position, following the cutting profile. Once the cut is complete, the database is updated at a step S23 to indicate the new cut depth (by adding the amount of material (cutting depth) removed in the present recut to the amount of material previously removed as indicated in the database).

It will be appreciated that the order of many of the steps in FIG. 2 are merely illustrative, and some steps may be carried out in a different order to that shown. For example, the fault detection (steps S4, S5, S6, S7) could be carried out first, or the steps S1 and S2 could be carried out after the wheel has been secured to the rotatable mount.

Referring to FIG. 4, the probe 7 is shown in an extended (left hand drawing) position and a retracted (right hand drawing) position. The probe 7 can be seen to comprise an extendable probe arm and a support arm, the support arm comprising a shaft 74 mounted within a sleeve (body) 72, the probe arm comprising a shaft 78 mounted within a sleeve 76. The probe 7 also comprises a sensor (not shown) which detects the position of the shaft 78 within the sleeve 76 and generates a signal output indicative of this position. It is this signal which is used to determine the surface elevation profile of the wheel. The sleeve (body) 72 of the support arm and the sleeve 76 of the probe arm are rigidly fixed together and the shaft 74 of the support arm and the shaft 78 of the probe arm are rigidly fixed together. It can be seen from the left hand of FIG. 4 that the shaft 78 of the probe arm may extend a substantial distance out of the sleeve 76. Due to the construction of this type of linear probe (which may for example be an Linear Variable Differential Transformer (LVDT) probe, the shaft 78 may be deflected laterally when extended, which may provide erroneous results. By mechanically coupling the probe arm to a support arm, which is of more rigid construction and uses a larger diameter shaft with bearings between the shaft and sleeve, the deflection of the probe can be avoided, or at least reduced, improving the accuracy with which the surface elevation of the wheel can be measured. It can be seen that the shaft 78 of the probe arm and the shaft 74 of the support arm are fixed together via a contact block 77 which carries a contact point 79 for contacting the surface of the wheel. In effect, the contact point 79 is constrained to move only vertically by the support arm (inhibiting deflection), while the vertical position of the contact point 79 is registered by the probe arm.

1. A method of recutting the surface of a wheel, the method comprising the steps of:
mounting the wheel on a rotatable mount;
moving a probe across the surface of the wheel between an outer radial position and an inner radial position to obtain a radial surface profile;
rotating the wheel about its axis on the rotatable mount;
during rotation of the wheel, controlling the position of a cutting tool with respect to the surface of the wheel to recut the surface of the wheel in accordance with the cutting profile;
tagging the wheel with a unique wheel identifier; and
recording the unique wheel identifier into a database in association with an indication of an amount of material which has been removed from the surface of the wheel.

2. The method according to claim 1, comprising storing a vehicle identification code into the database in association with the unique wheel identifier, the vehicle identification code uniquely identifying the vehicle associated with the wheel.

3. The method according to claim 2, wherein the vehicle identification code is a chassis number.

4. The method according to claim 1, comprising reading the unique wheel identifier prior to recutting the surface of the wheel and using the unique wheel identifier to obtain from the database an indication of the amount of material which has been previously removed from the surface of the wheel.

5. The method according to claim 1, comprising updating in the database the indication of the amount of material removed from the surface of the wheel to include the amount of material newly removed by the recutting process.

6. The method according to claim 1, wherein the amount of material removed is the depth of the cut made in the recutting process.

7. An apparatus for recutting the surface of a wheel, comprising:
a rotatable mount for receiving the wheel, and for permitting rotation of the wheel;
a probe, mounted to be movable across the surface of the wheel between an outer radial position and an inner radial position to obtain a radial surface profile;
a controller, operable during rotation of the wheel to control the position of a cutting tool with respect to the surface of the wheel to recut the surface of the wheel in accordance with the cutting profile;
a tag bearing a unique wheel identifier; and
a data connection, for recording the unique wheel identifier into a database in association with an indication of an amount of material which has been removed from the surface of the wheel.

8. An apparatus for recutting the surface of a wheel, comprising:
a rotatable mount for receiving the wheel, and for permitting rotation of the wheel;
a probe, mounted to be movable across the surface of the wheel between an outer radial position and an inner radial position to obtain a radial surface profile;
a controller, operable during rotation of the wheel to control the position of a cutting tool with respect to the surface of the wheel to recut the surface of the wheel in accordance with the cutting profile;
wherein the probe comprises an extendable probe arm and a support aim, the support a m comprising a shaft mounted within a sleeve, the probe arm comprising a shaft mounted within a sleeve, and a sensor for detecting the position of the shaft within the sleeve, wherein the sleeve of the support arm and the sleeve of the probe arm are rigidly fixed together and the shaft of the support arm and the shaft of the probe arm are rigidly fixed together.

9. The apparatus according to claim 8, comprising an arm mount bearing the cutting tool.

10. The apparatus according to claim 9, wherein the probe is removably mountable to the arm mount.

11. The apparatus according to claim 8, wherein the shaft of the probe arm and the shaft of the support arm are fixed together via a contact block carrying a contact point for contacting the surface of the wheel.

12-18. (canceled)
